(19) United States
(12) Patent Application Publication
(10) Pub. No.: US 2015/0336367 A1
(43) Pub. Date: Nov. 26, 2015

(54) HOT AIR ADHESIVE BONDING DEVICE

(71) Applicant: Xi'an Typical Europe GmbH, Kaiserslautern (DE)

(72) Inventor: Behzad SAFFARIAN, Kaiserslautern (DE)

(73) Assignee: Xi'an Typical Europe GmbH, Kaiserslautern (DE)

(21) Appl. No.: 14/716,942

(22) Filed: May 20, 2015

(30) Foreign Application Priority Data
May 24, 2014 (DE) 10 2014 107 340.1

(51) Int. Cl. B32B 37/06; B32B 37/00; B32B 38/18; B32B 37/12

(52) U.S. Cl. CPC B32B 37/06; B32B 37/1207; B32B 37/0046; B32B 38/18

(57) ABSTRACT

A hot air adhesive bonding device includes an adhesive bonding area for adhesively bonding two materials, of which one is provided with an adhesive that can be activated with supplied hot air, and a hot air device including an air heating device and an air application device directed at the material provided with the activatable adhesive in the adhesive bonding area, wherein the air application device exhibits an air chamber. The air heating device is designed as part of the air application device situated in the adhesive bonding area, and a wall of the air chamber that faces the material provided with adhesive is designed to allow thermal radiation to pass through.

### CROSS REFERENCE TO RELATED APPLICATIONS

Applicant claims priority under 35 U.S.C. §119 of German Application No. 10 2014 107 340.1 filed May 24, 2014, the disclosure of which is incorporated by reference.

### BACKGROUND OF THE INVENTION

1. Field of the Invention

The invention relates to a hot air adhesive bonding device.

2. Description of the Related Art

A hot air adhesive bonding device of the kind mentioned at the outset is known from patent document DE 38 41 580 C1. This device, which in the aforesaid document is referred to as a hot air welding machine, consist on the one hand of an adhesive bonding area for adhesively bonding two materials, of which one is provided with an adhesive that can be activated with supplied hot air. This device further exhibits a hot air device consisting of an air heating device and an air application device directed at the material provided with the activatable adhesive in the adhesive bonding area, wherein the air application device exhibits an air chamber. Both this device and the device according to the invention yet to be described below are used to heat the material provided with the adhesive (e.g., a plastic strip, in particular a so-called reflex strip for work clothes or leisure wear) shortly before combined with the other material (for example, cloth or fabric) by means of hot air, so that the adhesive is activated, and an adhesive bond comes about when the two materials are combined (during exposure to a contact pressure).

For the sake of completeness, reference is also made to patent document DE 39 11 360 A1, wherein the air heating device (there referred to as a hot air generator) is spaced a considerable distance apart from the air application device in this solution as well.

Reference is also made to patent document DD 265 114 A1, which discloses a device for heating and welding flat thermoplastic materials, but in which the heating wires are completely embedded in a thermal insulation block, and thus cannot impart their heat directly to the material to be welded via thermal radiation.

Finally, reference is also made to the further removed patent documents DE 198 23 042 C1 and GB 1 190 233 A.

### SUMMARY OF THE INVENTION

The object of the invention is to improve a hot air adhesive bonding device of the kind mentioned at the outset. In particular, a hot air adhesive bonding device that can be operated with less energy is to be provided.

This object is achieved with a hot air adhesive bonding device of the kind mentioned at the outset by the features according to the invention.

Therefore, the invention provides that the air heating device be designed as part of the air application device situated in the adhesive bonding area, and that a wall of the air chamber that faces the material provided with adhesive be designed to allow thermal radiation to pass through.

In other words, the solution according to the invention is characterized in particular by the fact that the air heating device is situated in or at least directly by the air application device. As opposed to the aforementioned prior art, in which the air heating device (there referred to as the hot air source 35) is spaced apart from the air application device, and hence also spaced apart from the adhesive bonding area, the measure according to the invention causes the hot air required for the adhesive bonding process to only be generated or heated immediately prior to its use. Apart from other advantages yet to be elucidated, this in particular minimizes heat losses, as a result of which the device as a whole requires less energy.

Other advantageous further developments of the hot air adhesive bonding device may be gleaned from the discussion below.

### BRIEF DESCRIPTION OF THE DRAWINGS

The hot air adhesive bonding device according to the invention will be explained in greater detail below based upon the graphic representation of a preferred exemplary embodiment.

### Shown on:

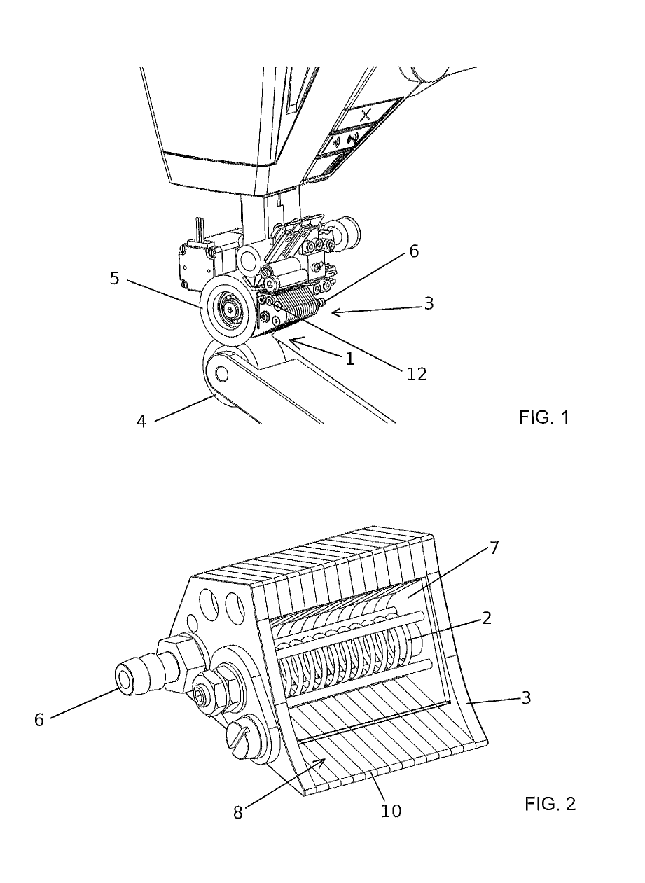

FIG. 1 is a perspective rear view of the hot air adhesive bonding device according to the invention;

FIG. 2 is a perspective left front view of the air application device with integrated air heating device (with transparent wall);

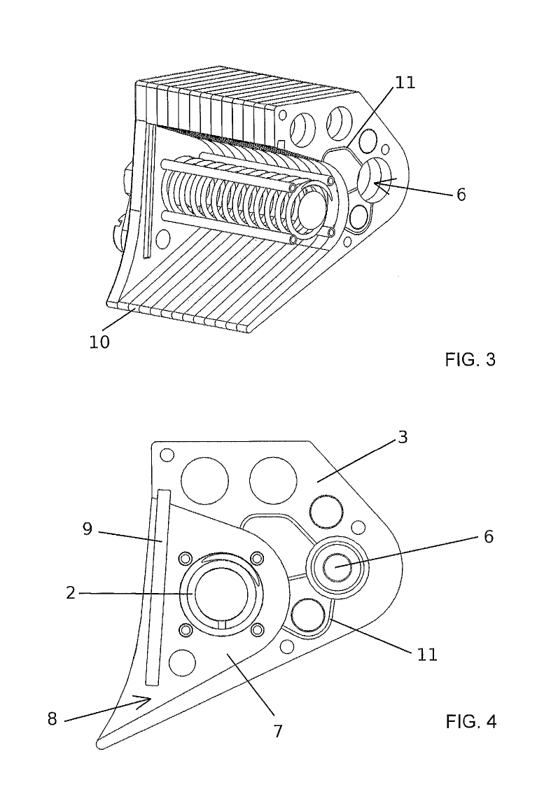

FIG. 3 is a perspective right front view of the air application device according to FIG. 2, but without side wall and without transparent wall; and on

FIG. 4 is another side view of the air application device with integrated air heating device.

### DETAILED DESCRIPTION OF PREFERRED EMBODIMENTS

As already explained at the outset, the hot air adhesive bonding device shown on the figures consists of an adhesive bonding area 1 for adhesively bonding two materials, of which one is provided with an adhesive that can be activated with supplied hot air. The term “air” or “hot air” is here always used as a synonym for any gas suitable for this intended use. In a known manner, the hot air adhesive bonding device also exhibits a hot air device consisting of an air heating device 2 and an air application device 3 directed at the material provided with the activatable adhesive in the adhesive bonding area 1, wherein the air application device 3 also exhibits an air chamber 7.

It is now essential with respect to the hot air adhesive bonding device according to the invention that the air heating device 2 be designed as part of the air application device 3 situated in the adhesive bonding area 1, and that a wall 9 of the air chamber 7 facing the material provided with adhesive be designed to allow thermal radiation to pass through. As opposed to the aforementioned prior art, the air heating device 2 is thus not positioned anywhere on the hot air adhesive bonding device, but rather directly by the air application device 3. The idea here underlying this measure is that the comparatively large air heating device 2 in prior art can be significantly diminished in size just by moving it close enough to the material provided with adhesive, and thereby keeping the flow path of the hot air short.

More particularly, it is preferred that a first guiding device 4 for the laminate material and a second guiding device 5 for the material to be adhesively bonded be provided in the adhesive bonding area 1 in addition to the air application device 3. As evident from the figures, the air heating device 2 is situated closer to the air application device 3 than to the guiding devices 4, 5. In addition, the air application device 3 is situated closer to the second guiding device 5 than to the first guiding device 4.

With reference to FIG. 1, it is further provided that the mentioned guiding devices 4, 5 each be designed as rotatable, preferably flexible rollers for pressing the two materials against each other.

In another significant difference from the aforementioned prior art, a gap is formed between the air application device and the guiding devices 4, 5, independent of operating phase. In other words, this measure implies that, given an interruption in the adhesive bonding process (for example, during a brief break at work), only the power supply to the air heating device 2 has to be interrupted, but the air application device 3 does not have to be removed from or swiveled out of the adhesive bonding area 1.

This step of swiveling out of the adhesive bonding area 1 had been absolutely necessary in the aforementioned prior art, since the previous air heating device 2 had to exhibit a distinctly higher output due to the longer flow path, and thus could not be turned on and off as quickly (residual heat owing to the higher thermal capacity of the heating element). Let it here be noted that the previously used air heating devices 2 usually have a power consumption that exceeds 3 KW, and generate an air flow of 150 1/min, wherein it is impossible to stop conveying the flow of air, the temperature of which is up to 700° C. in the adhesive bonding area 1, since the risk is otherwise that the heating coil, around which air would then no longer flow, will melt.

Focusing once more on the figures and again drawing reference thereto, the solution according to the invention preferably also provides that the air application device 3 exhibit an air feed port 6, the air chamber 7 connected with the air feed port 6, and an air outlet opening 8 connected with the air chamber 7.

The air feed port 6 is here designed for supplying air at ambient air temperature (i.e., air with a temperature of between 5° C. and 40° C.), which can be traced back to the fact that the air heating device 2 is (directly) situated in the air chamber 7 according to the invention. In addition, as evident in particular from FIGS. 3 and 4, it is provided that the air feed port 6 passing transversely through the air application device 3 is connected with the air chamber 7 by a plurality of distributor channels 11 that empty into the air chamber 7 at different locations and act uniformly on the air heating device 2.

More particularly, it is otherwise provided with respect to the air heating device 2 that the latter be designed as an electric heating element, or even more precisely as a helically coiled heating wire, wherein it is further especially preferred that a longitudinal axis of the electric heating element be designed to run parallel to the air outlet opening 8. Also provided inside the air chamber are bearing elements for supporting the heating element or the helically coiled heating wire.

It is further provided that the air heating device 2 in the air chamber 7 be situated between the air feed port 6 and the air outlet opening 8 as viewed in the direction of air flow, wherein the air outlet opening 8 is preferably designed as a slit that runs parallel to the material provided with adhesive.

In another feature of the solution according to the invention, a wall 9 of the air chamber 7 that faces the material provided with adhesive is designed to allow thermal radiation to pass through. It is especially preferred that this wall 9 here be transparent in design, wherein it is preferably also provided that an area of the air chamber 7 facing the material provided with adhesive be formed by the air outlet opening 8 on the one hand, and by the wall 9 that allows thermal radiation to pass through on the other. As tests have shown, using the radiant heat of the air heating device 7 makes it possible to limit the heating of the hot air to 200 to 300° C. and the volumetric flow rate of the hot air to 10 to 50 1/min at the same adhesive bonding capacity.

In order to prevent the material provided with adhesive from sticking to the wall 9, it is further preferred, but not additionally depicted on the figures, that the air application device 3 be provided with an air outlet opening for applying an air film to a side of the wall 9 that potentially faces away from the air chamber.

As evident from the figures, it is preferably also provided that the air application device 3 consist of a series of plates 10 stacked one on top of the other. The plates 10 are here preferably fixedly joined together with a connecting element 12 that perpendicularly passes through them (for example, a screw). In addition, the air application device 3 or each plate 10 at least partially consists of a ceramic material to increase its thermal resistance.

Finally, in order to prevent a user from being burned by the device according to the invention or in particular by the hot air device consisting of the air heating and air application device, the air application device 3 is preferably provided with a thermal protection cover that releases the air outlet opening 8 (once again not additionally shown).

### REFERENCE LIST

1 Adhesive bonding area
2 Air heating device
3 Air application device
4 Guiding device
5 Guiding device
6 Air feed port
7 Air chamber
8 Air outlet opening
9 Wall
10 Plate
11 Distributor channel
12 Connecting element

What is claimed is:

1. A hot air adhesive bonding device, comprising an adhesive bonding area (1) for adhesively bonding two materials, of which one is provided with an adhesive that can be activated with supplied hot air, and a hot air device comprising an air heating device (2) and an air application device (3) directed at the material provided with the activatable adhesive in the adhesive bonding area (1), wherein the air application device (3) exhibits an air chamber (7), wherein the air heating device (2) is designed as part of the air application device (3) situated in the adhesive bonding area (1), and wherein a wall (9) of the air chamber (7) that faces the material provided with adhesive is designed to allow thermal radiation to pass through.

2. The hot air adhesive bonding device according to claim 1, wherein a first guiding device (4) for the laminate material and a second guiding device (5) for the material to be adhesively bonded are provided in the adhesive bonding area (1) in addition to the air application device (3).

3. The hot air adhesive bonding device according to claim 2, wherein the air heating device (2) is situated closer to the air application device (3) than to the guiding devices (4, 5).

4. The hot air adhesive bonding device according to claim 2, wherein the air application device (3) is situated closer to the second guiding device (5) than to the first guiding device (4).

5. The hot air adhesive bonding device according to claim 2, wherein a gap is formed between the air application device (3) and the guiding devices (4, 5), independent of operating phase.

6. The hot air adhesive bonding device according to claim 1, wherein the air application device (3) exhibits an air feed port (6), the air chamber (7) connected with the air feed port (6), and an air outlet opening (8) connected with the air chamber (7).

7. The hot air adhesive bonding device according to claim 6, wherein the air heating device (2) is situated in the air chamber (7).

8. The hot air adhesive bonding device according to claim 6, wherein the air heating device (2) in the air chamber (7) is situated between the air feed port (6) and the air outlet opening (8) as viewed in the direction of air flow.

9. The hot air adhesive bonding device according to claim 1, wherein the air application device (3) is provided with an air outlet opening for applying an air film to a side of the wall (9) that faces away from the air chamber.
